(19) United States
(12) Patent Application Publication
(10) Pub. No.: US 2015/0352583 A1
(43) Pub. Date: Dec. 10, 2015

(54) SHIELDED SPRAYER APPARATUS AND METHOD

(71) Applicant: Ronald E. Anderson, Farwell, TX (US)

(72) Inventor: Ronald E. Anderson, Farwell, TX (US)

(21) Appl. No.: 14/733,906

(22) Filed: Jun. 8, 2015

Related U.S. Application Data
(60) Provisional application No. 62/009,284, filed on Jun. 8, 2014.

(51) Int. Cl. B05B 15/04; A01M 7/00; B05B 11/00

(52) U.S. Cl. CPC B05B 15/0443; B05B 11/3042; A01M 7/0046; A01M 7/0064

(57) ABSTRACT

Disclosed is an invention in the field of shielded sprayers. The present disclosure particularly relates to a spray shield which can utilize standard plastic bottles. In particular, a spray shield is described which attaches a standard plastic bottle to a trigger sprayer or wand sprayer assembly, wherein the plastic bottle is cut to provide an opening distally from the next portion of the bottle, allowing for the spray to be enclosed within the inner portion of the plastic bottle. The plastic bottle may be attached, incorporated, or anchored to the trigger sprayer or wand sprayer. The shield may be washable or disposable and is typically recyclable.

### CROSS-REFERENCE TO RELATED APPLICATIONS

This application claims the benefit under 35 U.S.C. 119(e) of U.S. Provisional Patent Application No. 62/009,284, filed on Jun. 8, 2014, which is incorporated by reference in its entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### TECHNICAL FIELD

The present disclosure relates in general to controlled application of a liquid. In particular, the present disclosure relates to a spray apparatus for the controlled application to a desired surface, without contacting undesired surfaces.

### STATEMENT OF FEDERALLY FUNDED RESEARCH

None.

### BACKGROUND OF THE DISCLOSURE

The use of chemical pesticides in the agricultural and lawn and garden industries is customary. Growers apply various chemicals to combat many undesired pests.

Chemicals such as insecticides, herbicides, fungicides, nematocides, and other pesticides may be used to optimize the growing environment of the desired plant. Additionally, fertilizers and other foliar feeds are often applied to increase the vitality and vigor of the desired plant.

Certain pesticides, such as herbicides, have modes of action which are toxic to certain plant species. Herbicides, also commonly known as weedkillers, are pesticides used to kill unwanted plants. Some herbicides are selective, having the ability to control certain targeted plant types or species, while not harming others. Selective herbicides control specific targets, while leaving the desired crop relatively unharmed. Some of these act by interfering with the growth of the weed and are often synthetic mimics of natural plant hormones. Examples of selective herbicides include 2,4-Dichlorophenoxyacetic acid (usually referred to by its abbreviation, 2,4-D) a common systemic pesticide/herbicide used in the control of broadleaf weeds. 2,4-D is often applied over the top of grasses, or monocots, for control of various broadleaf, or dicot, plants. Other herbicides are non-selective, killing any plant it comes in contact with. Herbicides used to clear waste ground, industrial sites, railways and railway embankments are not selective and kill all plant material with which they come into contact. An example of a non-selective herbicide is glyphosate, the common ingredient found in ROUNDUP® herbicide.

In many conventional agronomic situations, one of the more common forms of pesticide application is the use of mechanical sprayers. Hydraulic sprayers consists of a tank, a pump, a lance or wand (for single nozzles) or boom (for multiple nozzles), and a nozzle (or multiple nozzles). Sprayers convert a pesticide formulation, often containing a mixture of water (or another liquid chemical carrier, such as fertilizer) and chemical, into droplets, which can be large rain-type drops or tiny almost-invisible particles. This conversion is accomplished by forcing the spray mixture through a spray nozzle under pressure. The size of droplets can be altered through the use of different nozzle sizes, or by altering the pressure under which it is forced, or a combination of both. Large droplets have the advantage of being less susceptible to spray drift, but are often less effective in achieving adequate coverage. Due to static electricity, small droplets are able to maximize contact with a target organism, but very still wind conditions are required.

Spray applications are also considered a common approach in home lawn and garden applications as well, as wide variety of liquid products are sold in spray bottles or sprayers. With the use of trigger spayers, handheld tank sprayers and small spray booms, many lawn and garden pesitcide solutions are designed for applying pesticides in the form of a spray in order to contact the targeted plant or area. Similar to commercial agronomic situations, treating targeted areas in a small-scale or lawn and garden setting presents certain challenges with the use of spray applications to control unwanted weeds or pests.

It is common that non-selective herbicides, such as glyphosate, or other more selective pesticides which may nonetheless be harmful to the desired plants, are utilized via spray applications. In post-emergent settings when the desired plant is growing, there is a risk of having the non-selective herbicide come in contact with the desired plant, resulting in damage or death to the desired plant, rather than solely the targeted weeds. This incidental or accidental contact may result from having the weeds too closely incorporated with the desired plants, causing the spray application to broadcast spray onto both weeds and desired plants. In other situations, the inadvertent contact may result from wind drift, meaning the pesticide drifts in the air from the targeted area onto non-targeted areas, resulting in the pesticide coming in contact with desired plants or non-targeted areas. Due to the droplet sizes of the spray application there may even be a risk of wind drift when very little wind is present.

Other situations of incidental or accidental contact may occur when pressures vary with the spray application, resulting in accidental overspray. Similarly, misapplication may occur with handheld spray applications due misdirection or accidental discharge while moving the applicator to other areas. Indeed, it is difficult to limit the spray application solely to targeted weeds or areas.

In commercial agricultural settings which utilize rows, the use of hooded sprayers developed as a means for physically separating the spray application from the desired vegetation. The principle of guarding the desired plant from the spray of the pesticide using has become common practice in the industry. Typically, hooded sprayers are implements operated by tractors or specialized vehicles, with nozzles addressing each row of a single or multiple-row boom. Hoods are fashioned between or around each nozzle to ensure the spray is blocked from the desired crop, thus allowing for treating the areas between rows with herbicides without affecting the desired crop.

Additional sprayers utilize similar wind shielding approaches. Plot sprayers, such as those described in U.S. Pat. No. 6,698,668, utilize side walls to create and enclosed area for treating the desired area with a spray assembly moveably attached to a track assembly.

In the case of handheld spray applications, such as with the use of trigger sprayers or handheld tank sprayers, several examples incorporate the principle of the hooded sprayer, or physical separation of the desired plant or area from the spray application to a targeted plant or area.

U.S. Pat. No. 6,679,438 discloses a spray guard for use with the wand of a sprayer that has a nozzle, wherein an adapter is utilized having a flared skirt by which a conical shaped shield is secured to the adapter, thus providing a guard for the liquid spray. While addressing the shielding capability, the disclosed spray guard of the '438 patent utilizes an adapter with a flared skirt which utilizes a shield, requiring specifically designed shields and affixing means for such spray shield to the flared skirt of the adapter. The adapter is also permanently affixed to the lower portion of the wand, near the nozzle, and does not allow for adjustment up and down the nozzle shaft. Further the affixed shielded device is disclosed specifically for a wand sprayer. The spray shield further requires purchasing or preparing replacement shields.

U.S. Pat. No. 7,063,275 B2 discloses a sprayer comprising a spray shield; the spray shield, the hose and the body being configured so that the spray shield is removably attached to the body and configured for attachment to the hose proximate to the nozzle. While providing one example of a shield, the shield is a flat shield with a design for efficient storage contoured body of the sprayer, suggesting a unique product not applicable to other wand sprayers or trigger sprayers.

Other attempts utilize separate shielding devices from the sprayer itself. U.S. Pat. No. 6,065,244 discloses a spray shield having a generally funnel shaped body having an elongated slot extending along one side thereof to allow elongated plant stems to be inserted into the funnel shaped body through the slot. The apparatus may be positioned with the handle away from the direction of the spray.

U.S. Pat. No. 7,581,350 B2 discloses a shielding apparatus activated by a hand control mechanism while operating a sprayer with the other hand. The shield is designed to open and close around a plant stem to isolate the plant for spraying, while having an elongated shaft for shielding the plant from a safe distance. The shield is designed to prevent underlying growth from being sprayed by the spray above onto the plant.

Yet other attempts utilize targeted application approaches such as wicking or gravity-based targeting of desired plants. U.S. Pat. No. 5,499,474 discloses an applicator of herbicide wherein a liquid is applied into a fluid conduit which is affixed to a plant, utilizing a wicking feature to the surface of a plant. This applicator approach is designed for use with a pump bottle, and cites numerous previous attempts, incorporated by reference herein, for the controlled application of liquids, such as herbicides.

U.S. Pat. No. 7,988,376 B2 discloses a fluid application device comprising a holder, a tube connected to the holder, and a porous fluid applicator contained within the holder wherein the holder contacts at least a portion of a bottom surface of the porous fluid applicator, allowing the dispensing of fluid onto a target area without contacting a non-targeted area.

While it is known and desired that shields evolved from the original hooded sprayer approaches of commercial agriculture have application in many lawn and garden scenarios, many of the current approaches fail at providing a uniformly applicable spray shield to trigger and wand-based spraying devices. The current approaches further require specialized shielding components. It is therefore desired to have a solution to providing a spray shield capable of being utilized by a handheld trigger sprayer or wand sprayer for providing extensive coverage for protection of desired plants.

### SUMMARY OF THE DISCLOSURE

The present disclosure addresses failings in the art by providing a spray shield apparatus, which utilizes readily available and disposable shields, such as standard plastic bottles. In one aspect of the present disclosure, a trigger sprayer is manufactured having a standard plastic bottle screw lid or female receptacle surrounding the nozzle assembly of the trigger sprayer. In yet another aspect, the plastic bottle screw lid is constructed as an adapter with a slot provided in the middle of the cap for insertion of a sprayer wand. A wing nut or tightening screw is then utilized on the adapter to tighten the adapter against the wand at the desired position. Another aspect of the present disclosure includes a plastic bottle, such as a two-liter soda bottle, screwed to the screw lid assembly, in which the plastic bottle's lower portion is cut off to provide a cylindrical, circular spray shield affixed to the sprayer.

The present disclosure further provides an adapter for adjusting the size or neckfinish of the plastic bottle, such as for a 3-liter bottle. In accordance with another aspect of the present disclosure, the plastic bottle may be interchangeable and disposed of following one or more uses, in order to avoid cleaning or re-purchasing specialized shields.

The present disclosure further provides a tubular spray shield, which extends longitudinally from a trigger sprayer assembly or wand assembly. The spray shield may comprise a standard plastic bottle that is cut to provide an opening distal from the neck of the plastic bottle. The opened end then allows for the spray to be directed within the cylindrical bottle to the desired location while preventing wind drift or misapplication. The opening may be cut to the desires of the user depending on the nature of the desired spray pattern, spacing of the unwanted targeted plants, proximity of the desired plants, and size of the targeted plants. In another embodiment, the transparent plastic bottle assists the user in use and positioning the shield.

It is therefore an object of the present invention to provide a shielded sprayer comprising a female threaded cap assembly further comprising a spray nozzle protruding axially within said female threaded cap assembly, wherein a bottle may be affixed to said female threaded cap assembly, said bottle having been cut distally from the cap portion to provide an opening for directing spray from said spray nozzle.

It is another object of the present invention to provide an adapter for a sprayer comprising a female threaded cap assembly having a cavity for insertion of a spray nozzle, wherein a bottle may be affixed to the female threaded assembly for providing a shielded inner chamber for directing spray from said spray nozzle.

It is yet another object to provide a method for controlled application of a liquid from a sprayer, comprising providing a sprayer having a female threaded cap assembly comprising a spray nozzle protruding axially within said female threaded cap assembly affixing a bottle to said female cap assembly, wherein said bottle has been cut distally from the bottle neck to provide an opening directing the inner chamber of the bottle over a desired object or surface; and spraying said liquid within the inner chamber of said bottle onto the desired object or surface.

The various aspects of the present invention may include additional features, including a sprayer, which may be a trigger sprayer, a wand sprayer, and the like. The bottle may be a typical plastic bottle, and may further allow for cutting at the distal end of the bottle from the neck, to provide an inner chamber for spraying a desired surface or object with a liquid. The liquid may be a pesticide. Further, the liquid may be an herbicide.

### BRIEF DESCRIPTION OF THE DRAWINGS

The foregoing and other objects, features, and advantages of the disclosure will be apparent from the following description of embodiments as illustrated in the accompanying figures and drawings.

FIG. 1 depicts an exemplary trigger sprayer apparatus with a shield affixed to the trigger sprayer.

FIG. 2 depicts an exemplary trigger sprayer having an adapter of the present disclosure for affixing a plastic bottle serving as a spray shield.

FIG. 3 depicts a trigger sprayer having an adapter of the present disclosure wherein a plastic bottle serving as a spray shield is affixed to the sprayer.

FIG. 4 depicts a wand sprayer adapter of the present disclosure affixed to a wand and accompanying tank reservoir.

FIG. 5 depicts an enlarged view of the wand adapter for affixing a plastic bottle, which serves as a spray shield.

FIG. 6 depicts two variations of adapters for affixing plastic bottles which serve as spray shields, the left illustration being an adapter for a two-liter plastic bottle affixed to a trigger sprayer and the right illustration being an adapter for a three-liter bottle to then affix to the smaller diameter attachment means.

### DETAILED DESCRIPTION OF THE DISCLOSURE

While the making and using of various embodiments of the present disclosure are discussed in detail below, it should be appreciated that the present disclosure provides many applicable inventive concepts that can be embodied in a wide variety of specific contexts, goods, or services. The specific embodiments discussed herein are merely illustrative of specific ways to make and use the disclosure and do not delimit the scope of the disclosure.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

The present disclosure will now be described more fully hereinafter with reference to the accompanying figures and drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, compositions, processes, or systems. The following detailed description is therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

A “sprayer” is a device used to spray a liquid. A “liquid” may comprise various substances in liquid or aerosolized form, such as water, paints, cleaners, waxes, fertilizers, pesticides and finishes. Sprayers range in size from handheld units to trailed sprayers connected to a tractor with boom mounts. The sprayer may be a hand pump or trigger sprayer, a pressurized handheld wand sprayer, a hose sprayer, a double pressure sprayer, a mist blower, or backpack sprayer.

A “pesticide” is a substance meant for attracting, seducing, destroying, or mitigating any pest. They are a class of biocide. The most common use of pesticides is as plant protection products (also known as crop protection products), which in general protect plants from damaging influences such as weeds, plant diseases or insects. This use of pesticides is so common that the term pesticide is often treated as synonymous with plant protection product, although it is in fact a broader term, as pesticides are also used for non-agricultural purposes. The term pesticide includes all of the following: herbicide, insecticide, insect growth regulator, nematicide, termiticide, molluscicide, piscicide, avicide, rodenticide, predacide, bactericide, insect repellent, animal repellent, antimicrobial, fungicide, disinfectant (antimicrobial), and sanitizer.

In general, a pesticide is a chemical or biological agent (such as a virus, bacterium, antimicrobial, or disinfectant) that deters, incapacitates, kills, or otherwise discourages pests. Target pests can include insects, plant pathogens, weeds, mollusks, birds, mammals, fish, nematodes (roundworms), and microbes that destroy property, cause nuisance, or spread disease, or are disease vectors. Although pesticides have benefits, some also have drawbacks, such as potential toxicity to humans and other desired species. It is therefore an object of the present disclosure to avoid misapplication of pesticides which may be harmful to such desired species.

Often with the use of various sprayers, the application of pesticides, such as herbicides may harm the desired plants while attempting to control unwanted species, such as weeds. The harm to the desired plants may occur from airborne spray droplets coming in contact to the desired plants and potentially injuring or killing the desired plant. The airborne spray coming in contact with the desired plant may be due to wind borne droplets, or wind drift, which carries the spray droplets to an unintended location or surface. Similarly, carelessness or inaccuracy on the part of the user may result inadvertent application of spray droplets to desired plants rather than to the unwanted plants, or weeds.

A “bottle” used in the present disclosure means a rigid container for liquids. The bottle may often be constructed of plastic, referred to also as a “plastic bottle”. Plastic bottles are typically used to store liquids such as water, soft drinks, motor oil, cooking oil, medicine, shampoo, milk, and ink. The size ranges from very small sample bottles to large carboys. There are several types of plastic bottles. Polyethylene terephthalate (PET, PETE or polyester) is commonly used for carbonated beverage, water bottles and many food products. PET provides very good alcohol and essential oil barrier properties, generally good chemical resistance (although acetones and ketones will attack PET) and a high degree of impact resistance and tensile strength. PET bottles are often transparent and are often recyclable. Other types of plastic bottles include high-density polyethylene (HDPE), low-density polyethylene (LDPE), polyvinyl chloride, polypropylene, polystyrene, fluorine treated HDPE bottles, post-consumer resin (PCR), K-resin (SBC) and bioplastics having processed biological materials rather than petrochemicals as its primary polymer structure.

Accordingly, the present disclosure provides a spray “shield” or “guard” to block the spray droplets from coming in contact with surfaces and species that are not intended to be contacted. In one embodiment, the spray shield is a standard plastic bottle of desired size, such as a 2 liter soda bottle, a 3 liter soda bottle, or one liter water bottle, and the like. The spray is directed to the inside of the bottle by attaching a sprayer apparatus, such as a trigger sprayer or wand sprayer, thus positioning the nozzle to emit spray in the inner portion of the plastic bottle. In another embodiment, the user removes the lower portion of the bottle by using scissors, shears, a knife or other cutting utensil. The removed portion of the plastic bottle allows for an opening distally from the neck portion of the plastic bottle. The opening thus allows for the spray to contact the targeted surfaces exposed at the opening of the distal portion of the plastic bottle while preventing spray or drift by use of the side walls of the plastic bottle.

In another embodiment, the screw lid portion of spray shield of the present disclosure may be designed and manufactured as a part of a trigger sprayer or as a separately attached and retrofit adapter for adjustably affixing to a wand portion of a tank sprayer.

In turning to the drawings, the present disclosure provides a screw lid 12 for a standard plastic bottle 15 in which the screw lid is incorporated into a trigger sprayer 11 for a spray bottle 13 or affixed to a wand assembly 25 for a tank sprayer 27. The plastic bottle 15 is cut distally from the neck portion of the bottle to allow for an opening 22 distally located from the neck portion of the bottle. The inner chamber of the plastic bottle 16 is utilized for the spray stream, wherein the rigid sidewalls of the bottle 15 act as the spray shield.

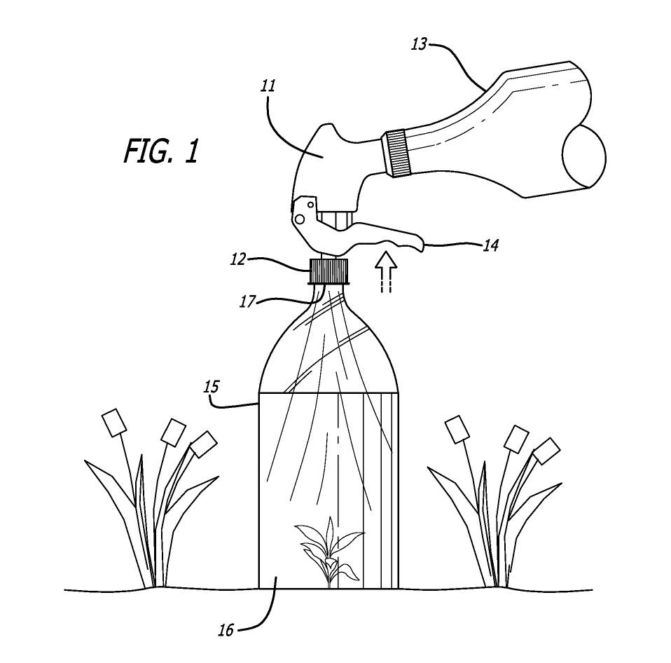

FIG. 1 illustrates and exemplary embodiment of the present disclosure incorporated into a trigger sprayer 11 for use with a spray bottle 13. The receiving or cap portion of a plastic bottle 12 is incorporated into the design of the trigger sprayer. In one embodiment the cap portion of the plastic bottle is molded as a part of the trigger assembly 11. In another embodiment, the cap is retrofitted to an existing trigger sprayer assembly having a strap, adhesive, or other means for affixing the cap portion of the plastic bottle to the sprayer, wherein the cap portion of the plastic bottle has an axial cavity for insertion of the nozzle portion of the trigger sprayer assembly. A plastic bottle's neck portion, providing a male threaded assembly is inserted 17 into the female threaded cap portion 12 affixed to the trigger sprayer assembly 11. Once attached to the trigger sprayer, the plastic bottle 15 provides an inner chamber 16 for spraying a targeted object. The shielded sprayer is positioned over a targeted area and activated 14 to discharge the spray droplets and cover the targeted areas. In another embodiment, the shield acts to direct spray toward a target not necessarily located within the inner chamber of the plastic bottle.

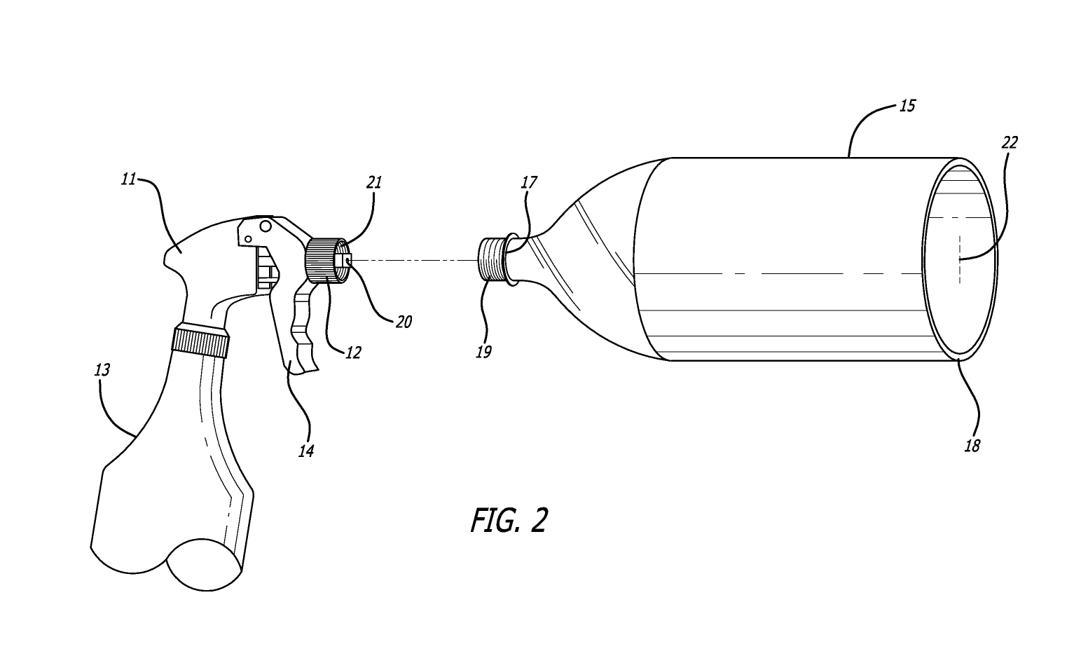

FIG. 2 depicts the female cap portion of the plastic bottle 12 having the nozzle portion 20 of the trigger sprayer protruded axially within the cap. The female cap contains threads 21 for screwing the plastic bottle's neck assembly 17 having a male threaded portion 19 for screwing into the trigger sprayer 11. The plastic bottle 15 is cut at the end distal to the neck portion of the plastic bottle to provide an opening 22 and distal edge 18 of the plastic bottle. The edge may be placed over a targeted plant or may simply represent the extent of the shielded area.

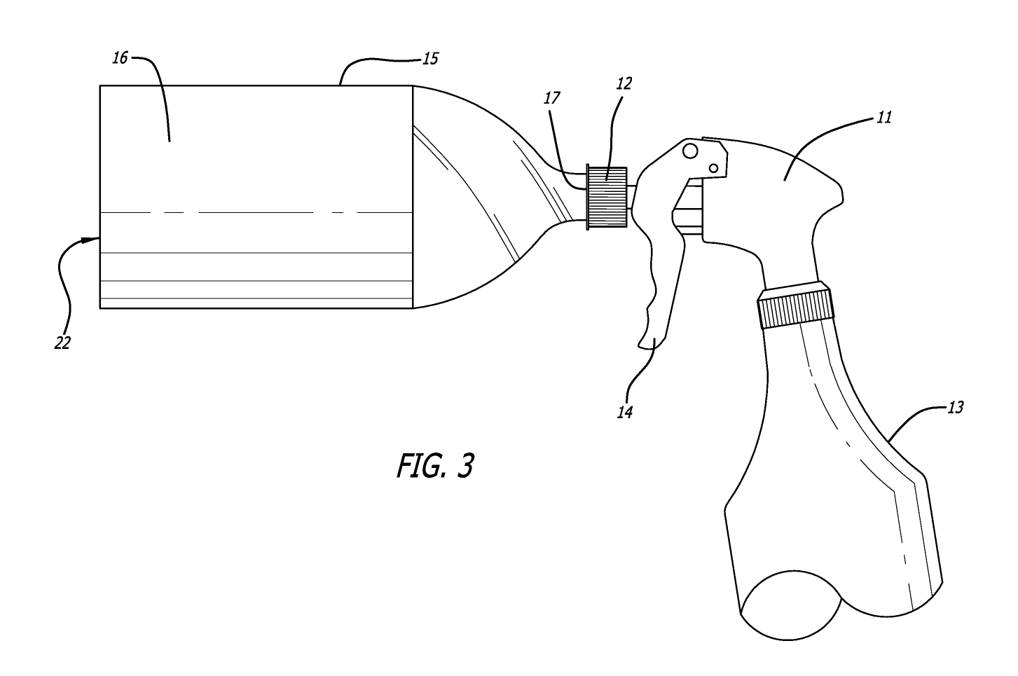

FIG. 3 illustrates an assembled shielded sprayer of the present invention. The plastic bottle 15 cut to have an opening 22 distally from the neck of the plastic bottle 17 provides an inner portion of the plastic bottle 16 that provides a circular shield for preventing the spray stream from drifting to non-targeted areas.

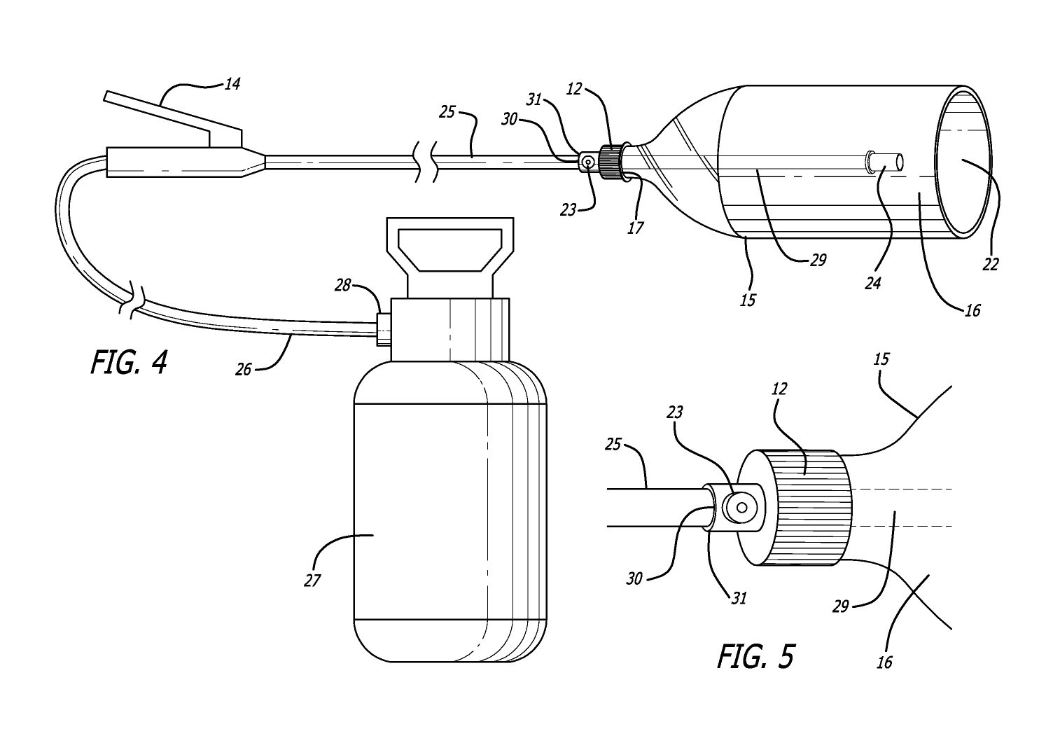

FIG. 4 illustrates another embodiment of the present disclosure, in the form of a wand sprayer adapter having a female threaded cap portion of a plastic bottle 12 affixed to a wand 25 and accompanying tank reservoir 27. The tank reservoir is pressurized, having a hose 26 affixed to the tank reservoir 28 for delivery to the wand sprayer 25. Once activated with a trigger device 14, the spray is discharged from the nozzle 24. In an exemplary embodiment of the present disclosure, the adapter contains an axial opening 30 for insertion of the wand 25 through the adapter 12. The adapter contains a tightening screw 23 for tightening the adapter at the desired portion of the wand. In another embodiment, the tightening portion 23 is a wing nut. In yet another embodiment the tightening portion 23 is a tensioner device such as a strap or belt. Once secured to the wand 25 a plastic bottle 15 is attached to the adapter utilizing the male threaded neck of the plastic bottle 17. The wand then protrudes 29 into the inner cavity 16 of the spray bottle. The distal portion of the spray bottle is cut by the user to provide an opening distal from the neck of the plastic bottle 22. The sprayer is then activated using a trigger mechanism 14 to provide a shielded spray toward a targeted area.

FIG. 5 is an exploded view of the adapter having a female cap portion of a plastic bottle 12, the cap containing an axial cavity 30 for insertion of a sprayer wand 25. The sprayer wand then protrudes 29 into the inner cavity of the plastic bottle 16. The adapter is secured to the wand utilizing a tightening screw 23. Alternatively, the adapter is secured by a wing nut, nut, or other tensioning device such as a strap or belt.

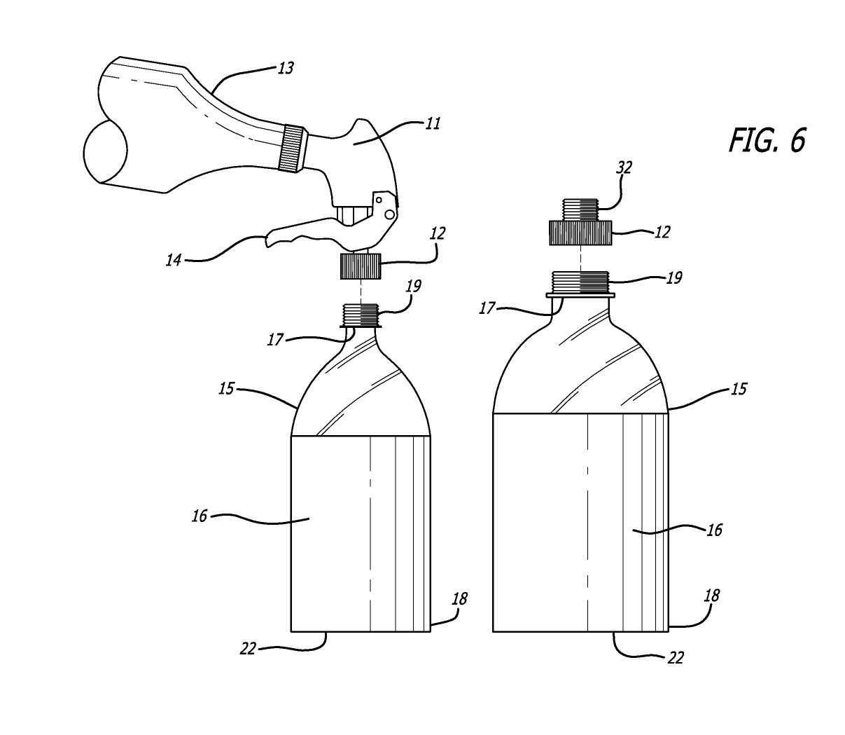

FIG. 6 illustrates two alternative assemblies for attaching a plastic bottle 15 to a spray bottle 13 having a trigger mechanism 11 having incorporated a female threaded cap portion of the plastic bottle 12 for screwing a plastic bottle's male threaded 19 neck portion 17 of the plastic bottle. The left assembly of FIG. 6 utilizes a standard plastic bottle where the female threaded cap portion 12 of the trigger sprayer fits the male threaded 19 neck portion 17 of the plastic bottle 16. The right assembly of FIG. 6 utilizes a thread adapter 32 for having different sizes of plastic bottle male threaded 19 neck portion. In one embodiment, the standard plastic thread size is for a 2-liter plastic bottle. In another embodiment, the thread adapter is set for attaching a 3-liter plastic bottle. In yet another embodiment, the thread adapter is set in accordance with various thread types and sizes set forth by the International Society of Beverage Technologists (ISBT), such standards incorporated herein by reference. A list various thread specs is available at http://www.threadspecs.com/threadspecs-downloads.asp.

Those skilled in the art will recognize that the methods and articles of the present disclosure may be implemented in many manners and as such are not to be limited by the foregoing exemplary embodiments and examples. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad combinations are possible in achieving the functions, features, interfaces and preferences described herein. Moreover, the scope of the present disclosure covers conventionally known manners for carrying out the described features and functions and interfaces, as well as those variations and modifications that may be made to the components described herein as would be understood by those skilled in the art now and hereafter.

Furthermore, the embodiments of methods presented and described in this disclosure are provided by way of example in order to provide a more complete understanding of the embodiments of the present disclosure. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and processes described above to obtain a result that remains within the scope of the methods described in this disclosure.

What is claimed is:

1. A shielded sprayer comprising a female threaded cap assembly further comprising a spray nozzle protruding axially within said female threaded cap assembly, wherein a bottle may be affixed to said female threaded cap assembly, said bottle having been cut distally from the cap portion to provide an opening for directing spray from said spray nozzle.

2. The shielded sprayer of claim 1, wherein said bottle is a plastic bottle.

3. The shielded sprayer of claim 1, wherein said sprayer is a trigger sprayer.

4. The shielded sprayer of claim 1, wherein said sprayer is a wand sprayer.

5. The shielded sprayer of claim 1, said bottle having been cut distally from the bottle neck to provide an opening allowing for the application of a liquid to the inner chamber of the bottle.

6. The shielded sprayer of claim 5, wherein said liquid is a pesticide.

7. The shielded sprayer of claim 6, wherein said pesticide is an herbicide.

8. The shielded sprayer of claim 1, wherein said bottle affixed to the sprayer provides an enclosed inner chamber for applying pesticide to surfaces and object inside the inner chamber while excluding surfaces and objects outside of said enclosed chamber.

9. An adapter for a sprayer comprising a female threaded cap assembly having a cavity for insertion of a spray nozzle, wherein a bottle may be affixed to the female threaded assembly for providing a shielded inner chamber for directing spray from said spray nozzle.

10. The adapter of claim 9, wherein said bottle is a plastic bottle.

11. The adapter of claim 9, wherein said sprayer is a trigger sprayer.

12. The adapter of claim 9, wherein said sprayer is a wand sprayer.

13. The adapter of claim 9, said bottle having been cut distally from the bottle neck to provide an opening allowing for the application of a liquid to the inner chamber of the bottle.

14. The adapter of claim 13, wherein said liquid is a pesticide.

15. The adapter of claim 14, wherein said pesticide is an herbicide.

16. The adapter of claim 9, wherein said bottle affixed to the sprayer provides an enclosed inner chamber for applying pesticide to surfaces and object inside the inner chamber while excluding surfaces and objects outside of said enclosed chamber.

17. A method for controlled application of a liquid from a sprayer, comprising:
providing a sprayer having a female threaded cap assembly comprising a spray nozzle protruding axially within said female threaded cap assembly;
affixing a bottle to said female cap assembly, wherein said bottle has been cut distally from the bottleneck to provide an opening;
directing the inner chamber of the bottle over a desired object or surface; and
spraying said liquid within the inner chamber of said bottle onto the desired object or surface.

18. The method of claim 17, wherein said bottle is a plastic bottle.

19. The method of claim 17, wherein said sprayer is a trigger sprayer.

20. The method of claim 17, wherein said sprayer is a wand sprayer.
